(19) United States
(12) Patent Application Publication
(10) Pub. No.: US 2016/0379220 A1
(43) Pub. Date: Dec. 29, 2016

(54) Multi-Instance Shared Authentication (MISA) Method and System Prior to Data Access

(71) Applicant: NXT-ID, Inc., Shelton, CT (US)

(72) Inventors: Andrew Tunnell, Palm Bay, FL (US); Sean Powers, Melbourne, FL (US); David Tunnell, Palm Bay, FL (US)

(21) Appl. No.: 15/191,466

(22) Filed: Jun. 23, 2016

Related U.S. Application Data
(60) Provisional application No. 62/183,298, filed on Jun. 23, 2015.

(51) Int. Cl. G06Q 20/40; G06Q 20/36; H04W 12/08; G06Q 20/38; H04L 29/06; H04W 12/06

(52) U.S. Cl. CPC G06Q 20/40145; H04L 63/10; H04L 63/0869; H04L 63/0861; H04W 12/06; H04W 12/08; H04L 63/0435; H04L 63/20; G06Q 20/3829; G06Q 20/36

(57) ABSTRACT

A system and method to backup data on an entity such as a smart wallet by storing the data on a separate entity using intelligently connected personalized authentication. A first entity authenticates with two or more entities prior to data transfer, that are intelligently connected, meaning connected only when functioning to authenticate with other entities to perform the functions of data release, transfer, distribution, backup, and restoration. A primary entity holding sensitive private information (such as a smart wallet) authenticating with a second entity (such as a USB memory device on a PC), and a third entity (such as a cloud based server) before data is released or distributed to another entity. The system and method may personalize the data to the data owner by first requiring authentication of the owner.

### CROSS-REFERENCE TO RELATED APPLICATIONS

This patent application claims priority to a provisional patent application filed on Jun. 23, 2015 and assigned Application No. 62/183,298, which is incorporated herein in its entirety.

### FIELD OF THE INVENTION

The present invention relates to the general field of authentication, specifically improved authentication techniques prior to information transfer, storage, backup, and retrieval using multiple instances of authentication shared across multiple devices.

### BACKGROUND OF THE INVENTION

New technological advances have made everyday living so much easier, and now more can be done with a handheld device than ever before. With this growth in convenience, a new need has arisen: the need for protection of private information stored on wearable, mobile, internet of things (IOT), and other devices, along with customary devices, such as personal computers and servers. Whether it is a result of misplacement or theft, information can be easily lost and thus the need for backup of information has arisen.

Backing up data has previously been accomplished through the basic method of connecting a first device or entity (a mobile device for example) to a second device or entity (a mobile or non-mobile device for example) and duplicating a copy of all or identified data stored on the first device onto the second device. Generally, the first device is a mobile device although such is not required, albeit more practical. With such simple backup solutions it remains possible to lose a tremendous amount of data, thus the issue of security continues to be increasingly prominent.

Prior art includes methods wherein a computing device is backed up to a memory device such as portable hard drive, server computer, or other memory devices such as that outlined within U.S. Pat. No. 8,812,614. The data can then be restored to the originating computing device in event of data loss or when a new computing device has been acquired.

US published patent application number US20080301003 describes a physical connection between an authentication device and a local computer to perform offline DRM (digital rights management) authentication.

Other prior art such as described in US published patent application number 2013/0010959 allows for the data backup of a device (a smart phone) through a direct connection to a backup device (a computer).

Unfortunately, these and other methods of backing up data do not embody techniques that guarantee authentication of the user as part of the back-up process. Instead, these prior art techniques tacitly assume the user has been authenticated to backup data from one device to another and/or restore data to either of the devices. Authentication, if any, is performed only between the two devices or applications, i.e., the two devices are authenticated to each other and thus each device can “trust” the other and “trust” the data to be sent or received between them. This authentication process is conducted without regard to the legitimacy of the user/owner of the data who will be conducting the transfer or backup process.

Furthermore, for convenience, connectivity between the devices is generally performed over a network that is subject to possible intercept by operating systems that can be infected by malware and viruses over open and public communications networks.

Another prior art technique as described in US published patent application number 2014/0122432 utilizes a UPC or bar code to authenticate a user.

Published patent application number WO 2011/131141 uses a passive optical network (PON) to authenticate devices before information is shared.

US published patent application number 2005/0228994 describes a method to backup data using a key for encryption.

EP 1586973 describes user access information by entering a password, which is then transformed into a reissue key for retrieval.

In published patent application number WO 2009/038535 a computer authenticates with a server to send encrypted data.

In yet another prior art reference, US published patent application 2013/0145447, a device is backed up by a server using an authorization code as well as a user device key.

Methods that require direct communications between the two proximate devices have security advantages, but are often negatively impacted by usability disadvantages. The mandatory positioning of two devices through a direct line-of-sight communications, as described in US published patent application number 2013/0237155, is also disadvantageous to usability, since both devices must be within direct sight of each other.

Each of these over-the-air and physically-connected prior art techniques (i.e., wherein two entities are physically linked to establish a communications link between them) have trade-offs, but there is no known method or system to transfer (such as for data backup and/or data restore purposes, also referred to as data replication or data copying) personal data, such as data stored on a smart wallet, to a secure memory that is personalized such that the data transfer is wholly under control of the data owner, and requires prior authentication by more than one “entity.” Authentication by more than one entity provides a higher degree of data security than is provided by single-entity authentication of the prior art.

### BRIEF DESCRIPTION OF THE DRAWINGS

FIG. 1 illustrates examples of restrictions that a user may place on data stored on one or more entities.

FIG. 2 illustrates devices within an ecosystem of the present invention.

FIG. 3 illustrates authentication of three entities.

FIG. 4 illustrates an exemplary trusted ecosystem.

FIG. 5 illustrates authentication between two devices.

FIG. 6 illustrates authentication among three devices.

FIG. 7 illustrates an exemplary scenario in which two different authentication instances are executed.

FIG. 8 illustrates an exemplary scenario in which two different communication techniques are used to authenticate devices.

FIG. 9 illustrates a plurality of different authentication combinations for accessing different levels of secure data.

### DETAILED DESCRIPTION OF THE PREFERRED EMBODIMENTS

Before describing in detail the particular methods and systems related to a requirement for multiple authentications prior to data transfer, it should be observed that the embodiments of the present invention reside primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments.

The presented embodiments are not intended to define limits as to the structures, elements or methods of the inventions, but only to provide exemplary constructions. The following embodiments are permissive rather than mandatory and illustrative rather than exhaustive.

The present invention comprises methods and systems to substantially reduce the probability of a hacker gaining access to unauthorized memory (and thus the data stored in the memory) residing on an entity. To accomplish these objectives, the present invention comprises several methods and devices and systems to authenticate entities involved in a data transfer.

Multi-instance shared authentication (MISA): This invention describes a method and system to ensure an owner controls access and distribution of his or her data and information. In one embodiment management of information by its owner is assured by sharing authentication across one or more instances of authentication with one or more devices, computers, users, applications, software, websites, application programmer interfaces (API), software developer's kit (SDK), servers, services or the like, called “entities” herein, and shared across one or more communication links or protocols. This method is called “multi-instance shared authentication” or “MISA” for short herein.

Defining entities: References to entities herein may refer to electronic devices that store and process data, including devices that are portable, mobile, or static. Operation of such devices typically requires the use and processing of data to perform a function, such as the functions associated with a smart phone. Such devices therefore may comprise a processor that controls operation of the device, (such as a mobile phone). In certain instances references to “entities” or “entity” may refer to a human user.

Where is your data, who has access to it, when was it released, and to whom was it released? Data management across multiple devices has always been a challenge. Users typically possess more than one computer or computing device, a smart phone and a wallet or another device, purse, bag, container, receptacle, wearable, etc. to carry personal information such as identity and payment information. With the introduction of wearables on the market and the impending explosion of the internet of things (IOT), the location of a user's data is becoming more abstract, and our ability to secure data across a plethora of entities is less tenable.

Not all data is treated the same (some is more sensitive than others): “Data” is sometimes used interchangeably with “information” herein, and since all data is not the same, the sensitivity of communicating that data is not the same. For instance, data may consist of public information such as an individual's name, phone numbers, preferences and the like, called “public information” herein, while personal information may include but is not limited to identification information, financial information, and other personal information, called “private information” herein, that a user may wish to keep private in most circumstances, but may wish to share for various functions such as but not limited to proof of identity or payment transactions. In many instances, a user or owner of the data (user and owner used interchangeably herein) may desire for private data to remain private.

Protecting data: Privacy may be preserved by techniques, methods, and structures such as but not limited to encrypting, encoding, and/or modifying the data and requiring some authentication to access data and the like. Other methods to preserve privacy involve how devices and users authenticate with one other to form “circles of access” among “trusted” entities as described in the co-owned non-provisional patent application Ser. No. 14/217,289 entitled Universal Authentication and Data Exchange Method, System and Service filed Mar. 17, 2014, which is incorporated herein by reference. This method and system involves growing “trust” among devices that are “inter-aware” of one another through historical interaction and authentication such as but not limited to “Dynamic Pairing” as described in another non-provisional co-owned patent application and assigned application Ser. No. 14/217,202 entitled The Un-Password: Risk Aware End-to-End Multi-factor Authentication via Dynamic Pairing, which is incorporated herein by reference. Thus, according to this invention, entities increase trust as the history of interaction increases, much like how people get to know other people through interactions in various circumstances, by seeing them, hearing their voices, and observing the faces and mannerisms over time.

Trusted ecosystems via dynamic pairing: The present invention supports trusted networks or “ecosystems” consisting of an inter-aware device(s) or entity (entities) that may be formed through interaction between entities that are inter-aware via authentication methods such as but not limited to dynamic pairing. Dynamic pairing is a particularly attractive method of cryptographic authentication in that it provides authentication to endpoints via innovative pairing techniques that bind entities without actually passing any information from which the identifiers could be derived. For each authentication, this method masks risk scores based on authentication scores derived from various parameters collected from one or more authentication methods. Because of its innovative design, dynamic pairing is one way to add security to other existing authentication, encryption and compression methods to keep data private.

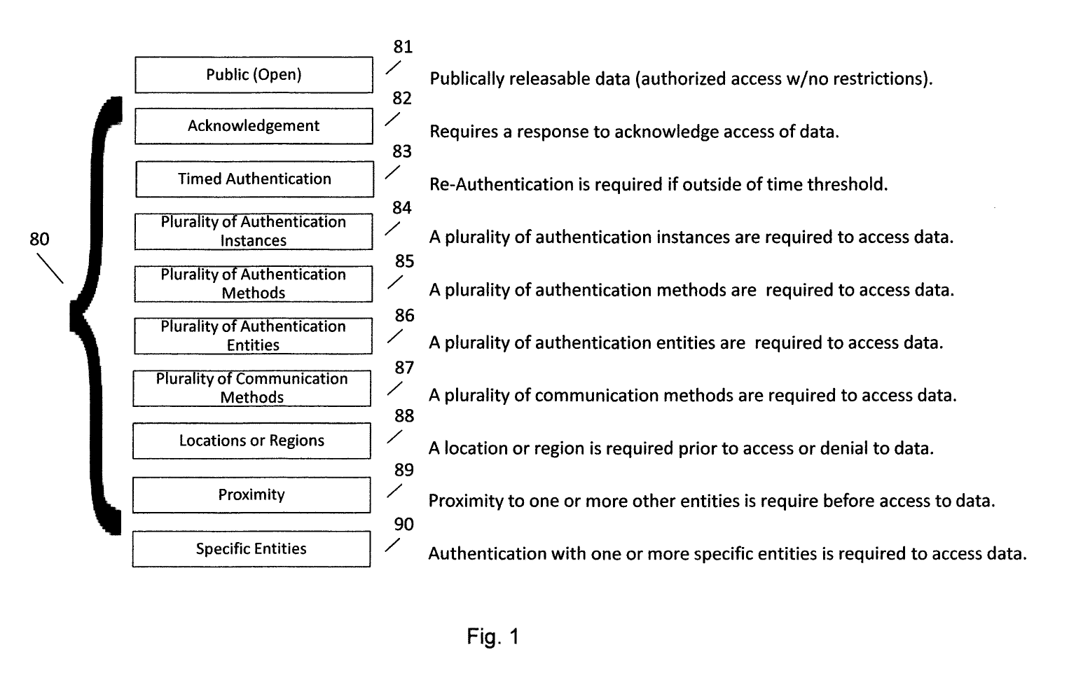

Circles of access: Circles of access are formed among these trusted ecosystems that govern which entities have access to which data. Users may set restrictions governing the authentication and encryption related with the release of data by one or more entities as described in FIG. 1. FIG. 1 illustrates non-limiting examples of restrictions 80 that users may place on data on one or more entities, including but not limited to none 81, wherein access to (or release of) data is authorized to be shared publically; acknowledgement 82, wherein a response is required to acknowledge prior to access of the data; timed authentications 83 wherein authentication is only required if authentication has not been occurring with some time threshold; for a plurality of instances 84 wherein a second or more instances of authentication are required prior to data access; for a plurality of entities 86 wherein authentication with a second or more entities is required prior to data access or release; for a plurality of communication methods 87 wherein a second communication method or more is required prior to data access or release; for a location and/or region 88 wherein a determination of one or more locations or regions is required prior to data access or release; data access is denied to one or more locations or regions; for proximity 89 wherein one or more other entities are required be proximate before data is accessed or released; for specific entities 90 such specific entities must authenticate prior to data access or release.

Defining entities: As used herein, “user” may refer to individual persons, organizations, companies, entities or the like, be they humans using computer interfaces or computers using computer interfaces, that desire or need to access, store, add, modify, delete, manage and/or transfer data. Like users, one or more other entities such as but not limited to devices may also require access to data resident within one or more other entities.

Form factors and intelligently connected ecosystems: The invention is not limited to any one specific form factor or device, but may be applied to electronics within various entities including IOT (Internet of Things) devices, wearables, portables, mobile devices, computers and the like.

Improved security through distributing authentication across pluralities of entities, authentication and/or communication methods: This invention ensures privacy by requiring a plurality of authentication instances across a plurality of entities, in some embodiments, or across a plurality of authentication methods, in other embodiments, or across a plurality of communication methods, in yet other embodiments, or combinations of these in some embodiments. The present invention can be used in conjunction with any data transfer between two or more entities including but not limited to data release, data access, data distribution, data backup, data restore, for use, for example, in payment or financial transactions and the like.

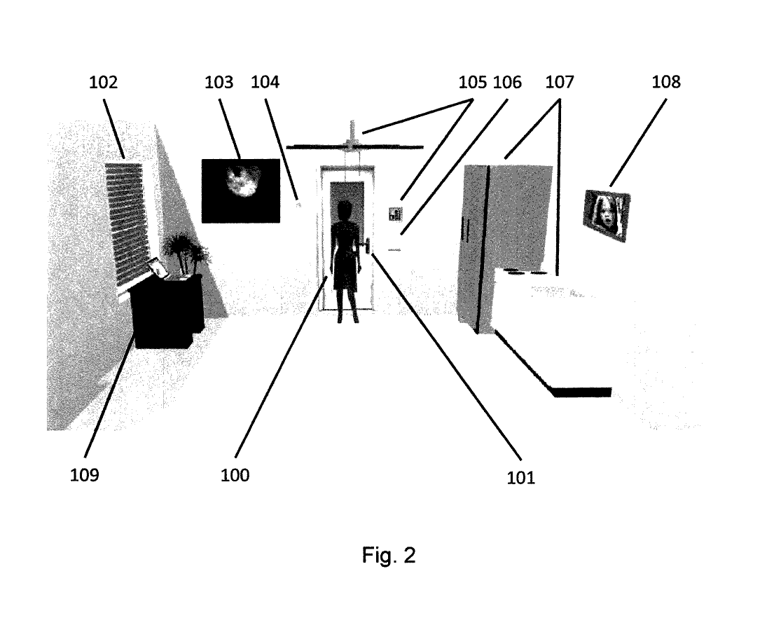

Defining entities within ecosystems: For instance, mobile, wearable and other transitory systems or devices may authenticate within one or more IOT (Internet of Things) ecosystems as described in FIG. 2. Under this embodiment, a transitory entity such as a wearable watch 100 (not shown) could interact with one or more other IOT devices within a private ecosystem such as but not limited to a home. IOT devices include but are not limited to wearables on an individual 100, and/or door locks 101, blinds 102, televisions 103, home automation devices, thermostats 104, lights, fans, light switches 105, alarm systems 106, appliances 107, digital picture frames 108, cooking tools, music equipment, gaming equipment, desktop computers, computer servers, laptop computers 109, vehicles, garage door openers, keyless locks and other devices that facilitate the “internet of things”, some of which are illustrated in FIG. 2.

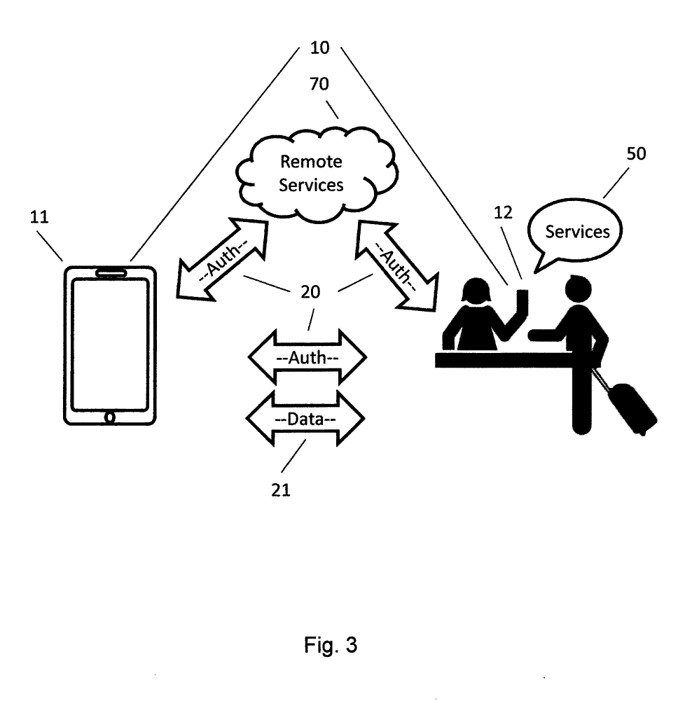

Likewise, transitory entities may interact with other entities 10 such as but not limited to point-of-sale (POS) entities 12 as shown in FIG. 3. Under this embodiment, a first entity 12 (point of sale device as a non-limiting example) may interact with a second 11 (a phone in this non-limiting example) and third entity 70 (a remotes service on a server (not shown) on the internet or device (not shown) in a cloud, as non-limiting examples), wherein the second entity is local and the third entity (a device in the cloud) could be remote to the first and second entities. Under this example, access to data 21 requested from a first entity (Point of sale) from a second entity 11 (phone) is not released until a third entity 70 (remote service 70 on some device on the internet or cloud) authenticates 20 the first entity 12 (point of sale device) and reports that to the second device 11 (phone). Likewise, the same multi-instance shared authentication methods could be applied to an application, software, API (application programmers interface), service 50 or the like, called “services” herein, on the first entity 12 or a remote service 70 residing on a device on the internet or in the cloud.

Defining devices: Any of the following may be considered devices.

Wearables may include but are not limited to watches, wrist bands, bands, jewelry, shirts, pants, belts, belt buckles, buttons and the like. Jewelry could include but is not limited to rings, bracelets, anklets, necklaces, ear rings, nose rings, cuff links and the like.

Portables may include but are not limited to wallets, cards, smart cards, smart wallets, key chains, accessories, glasses, FOBs, pens, and the like.

Mobile devices may include but are not limited to phones, tablets, laptops, and the like.

Computers may include but are not limited to a point-of-sale (POS) terminal or a device operative with a point-of-sale location, personal computers, servers and the like.

Defining private and public networks: Entities may communicate with one other directly over physical or wireless communications, or via point-to-point or peer-to-peer or other private or public networks or ecosystems and the like, collectively called an “ecosystem” herein. As referenced herein, a private network or ecosystem uses various methods to communicate including but not limited to private internet protocol space, i.e., private internet addresses, such as within a home, office, or enterprise. A local area network (LAN) is one form of a private network. As entities authenticate and interact with one another, they become familiar with one another through a history of interactions. Authentication methods such as the aforementioned dynamic pairing leverage this history of interactions to form a “trusted ecosystem”.

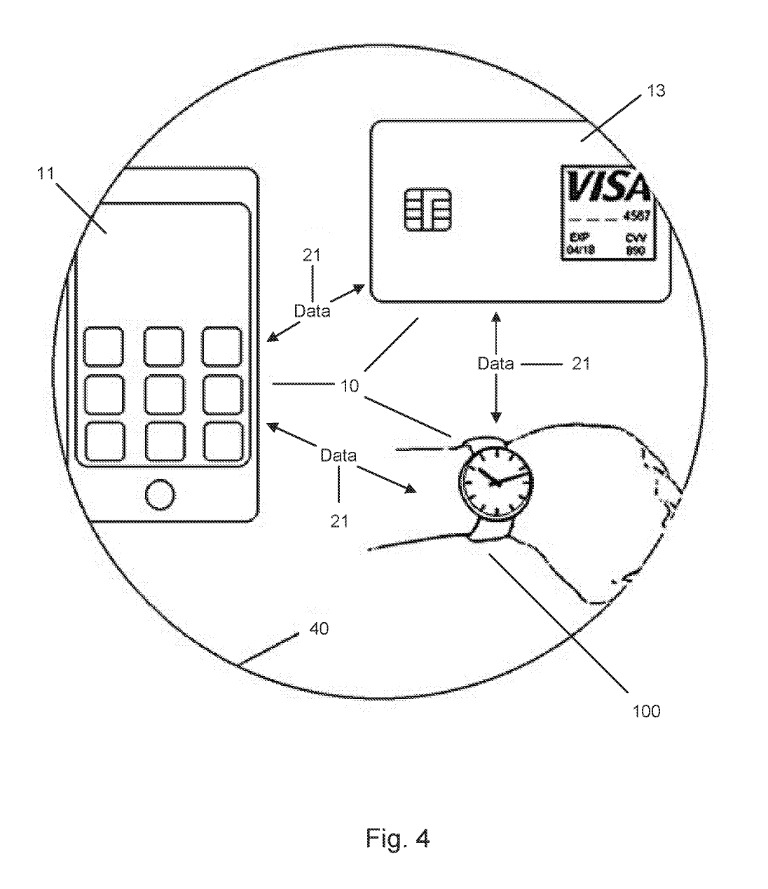

FIG. 4 illustrates an example of a trusted ecosystem 40 wherein a first entity (phone 11 as a non-limited example), a second entity (watch 100 in this example) and a third device (smart card 13 as a non-limited example) all “trust” one another based upon previous authentications and interactions. Thus, under this embodiment, data 21 may be passed between entities 10 without constant and continuous authentications, because they belong to a “trusted ecosystem” 40. Even so, data from a third entity (smart card 13 in this example), may ask for authentication with a first entity (a phone 11 in this example) and a second entity (a watch 100 in this example) before releasing data to any entity 10. This example demonstrates data that requires multiple entities 86 or proximity 89 prior to allowing access to data residing on the third entity (smart card 13).

A public network, in contrast to a private network, contains few restrictions and access rules established to limit access as with private networks. Likewise, grouping, clusters and/or interactions between entities are not limited to a single “ecosystem”, but rather transcend entity interactions, network topologies, and communications methods. Anyone may gain access to a public network and through it connect to other networks or the Internet and/or cloud.

Intelligently connected entities: Entities are said to be “intelligently connected” when they are disconnected at times, and only connect at other times such as but not limited to when some trigger or activity requires connectivity. Intelligent connected entities improve security of data by remaining disconnected and only connecting at times when connectivity is required to transfer data, perform services and the like.

Communications methods: Communication methods may include but not be limited to physical as well as wireless interfaces as well, such as but not limited to Bluetooth, Bluetooth Low Energy (BLE), beacons, WiFi, RFID (Radio Frequency Identification), wake-up signals, communications “advertisements”, RF/wireless/cellular data protocols and the like.

Defining memory: The invention may be applied to data stored within online or offline memory. “Online memory” refers to memory that is accessible from more than one location or device via a network or other electronic communications medium. “Offline memory” or “local memory” includes data that is accessible only from a local network or ecosystem that is either disconnected or intelligently connected. “Intelligently connected” refers to memory that may be accessed infrequently or at non-specific times.

Partitionable memory: In many cases, online storage is partitionable so that more than one user may access his/her assigned partition. Access control techniques are provided so that authorized users can access a given partition of memory while unauthorized users cannot access that partition, within security restrictions such as but not limited to those described in FIG. 1.

Defining access: “Access” may include the ability to read, write, modify, delete, transfer, etc. data (and/or meta data) from a memory or a memory partition. The data can be in the form of data records, files, blobs or other data structures, and may require authentication prior to access.

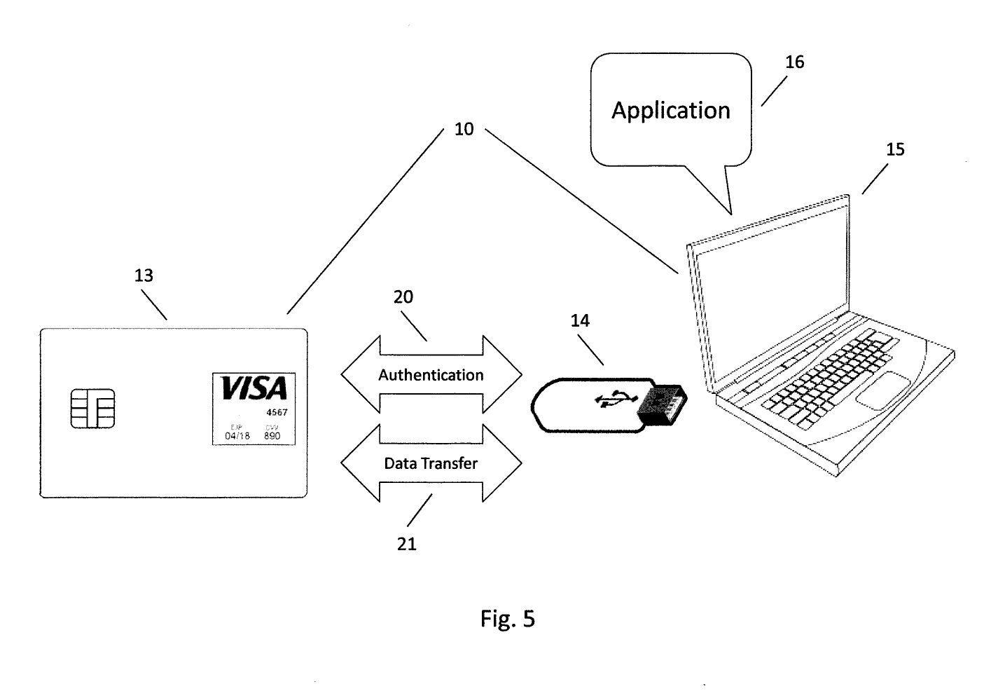

Defining authentication: As used herein, authentication is a process in which credentials or identification information provided by one or more entities are compared with credentials stored in memory. Credentials may reside on a database resident to a local entity or remotely within one or more authentication entities or services. If the presented credentials match the stored credentials, the authentication process is successful and the first entity is granted authorization to access the second entity as shown in FIG. 5.

FIG. 5 illustrates authentication 20 between two entities 10 prior to data transfer 21 between the two entities 10. In this non-limiting example, a first entity (a smart card 13 as a non-limiting example) authenticates with a second entity (USB device 14 containing some memory as a non-limiting example) before transferring data 21 (either entity sending and/or receiving data). Alternatively, authentication may take place between a first entity (smart card 13) a third entity (a laptop computer 15 or an application 16 or service (not shown) on a laptop computer 15 in this non-limiting example) prior to transferring data between a first entity (smart card 13) and a second entity (USB device 14), as a non-limiting example. As depicted by arrowheads 20 and 21, the authentication process may be considered bi-directional and the data transfer process may also be considered bidirectional, in some embodiments.

User authentication methods: User authentication occurs within most human-to-computer interactions by user entry of identification characters, numbers and/or symbols typically followed by entry of a unique password comprising a second set of characters, numbers and/or symbols called “authentication credentials” herein. Successful matching of the credentials permits access to memory on an entity (or to the entity). In some embodiments, user authentication is required, thereby requiring human-to-machine interactions in operating systems, applications, wired networks and wireless networks to enable access to networked, Internet-connected and intelligently connected systems, applications and resources.

Credentials for use in authentication instances: As described above, in private and public computer networks (including the Internet), authentication is commonly accomplished through the use of login IDs (e.g., user names) and passwords. Knowledge of these login credentials is assumed to guarantee that the user is authentic and therefore permitted to access the network or devices connected to the network.

Password-based authentication: To gain access using this common “password-based authentication, each user initially registers (or is registered by someone else, such as a systems administrator), using an assigned or self-declared login ID and a password. On each subsequent use, the user must enter the login ID and the password. However, password-based authentication is not considered to provide adequately strong security for any system that contains sensitive data.

User names are frequently a combination of the individual's first initial and last name, which makes these users names easy to guess. If constraints are not imposed, users often create weak passwords. And even strong passwords may be stolen, accidentally revealed, or forgotten.

Password-based weaknesses: Password-based authentication weaknesses can be addressed, at least to some extent, with smarter user name and password rules, such as minimum length and stipulations for complexity, such as including capitals and symbols.

For these and other reasons, Internet accesses and many other transactions require a more stringent authentication process, such as an authentication process according to the present invention.

Authentication factors: Generally, an authentication factor is a category of credentials used for identity verification. The three most common categories are often described as something you know (the knowledge factor), something you have (the possession factor) and something you are (the inherence factor). Another category of authentication includes some movement you make (the behavior factor).

Authentication methods: Authentication methods may use one or combinations of authentication credentials including user input (knowledge), an entity or device (possession), biometrics (inherence), and/or behavior metrics (movement or action). User input methods include but are not limited to user names, PIN (Personal Identification Number), tap code, dynamic and hidden PINs and the like, some of which are described in depth in the co-owned provisional patent No. 62/198,817 entitled Methods and Systems Related to Multi-Factor, Multi-Dimensional, Hidden Security PINs, filed on Jul. 30, 2015. A device or entity in the possession of a user is another method to authenticate. Biometrics may include but are not limited to fingerprint, handprint, voice, face, expression, IRIS, eyes, scent, DNA, heartbeat and the like. Another category of authentication includes behavior metrics, which include but are not limited to body movements, finger or hand movements, and/or movements of devices as described in the co-owned provisional patent application No. 62/188,684 entitled Behavioral-Directed Authentication Method and System, filed Jul. 5, 2015. Last, there are combinations of each, such as “Position PINs”, which combine tap codes with the position of a device as the code is entered.

Distributed authentication across multiple devices: These and other authentication methods generally describe a user authenticating with a device, application or website. According to this invention, users as well as devices authenticate with other entities by leveraging authentications with other entities to form a trusted network or ecosystem.

Those skilled in the art are aware of many authentication techniques, including symmetric, asymmetric and/or combinations of authentication methods to authenticate between and among entities. Authentication may also be accomplished by the issuance of a digital certificate issued by a certificate authority.

With the increasing number of network-enabled devices, reliable machine authentication is crucial to allow secure communication in these networked environments. In the Internet-of-things scenario, which is increasingly becoming a reality, almost any imaginable entity may be made addressable and capable of exchanging data with another entity over a network. But each network access point is also a potential network intrusion point. And once the network has been breached, the hacker is one step closer to gaining access to entities connected to the network.

With typical authentication processes used today, a user (who may also be the data owner) must first authenticate with one or more entities prior to data transfer. The authentication may be executed “remotely,” wherein the user enters identification information to a computing device over communications systems that traverse multiple network nodes, services and the like. These communications are typically “public”, and thus, subject to potential compromise.

In one embodiment of this invention, the authentication may be executed locally or “privately” wherein the user enters identification information directly to the first entity or enters the identification information over a private network or enters the identification information from an entity in private, direct communication with the first entity, considered “private authentication” herein.

Local Communication Methods: “Private communication” herein refers to specific communication methods that require two or more entities to be within line of sight of one another, typically in very close range such as the trusted ecosystem depicted in FIG. 4. Entities may communicate with one other directly over physical or wireless communications, or via point-to-point or peer-to-peer or other private or public networks or ecosystems and the like.

Like FIG. 4, FIG. 5 shows another non-limiting example of private communication methods that require close proximity including NFC (near field communication) and Bluetooth and BLE “whisper mode” and the like, where the radios transmit and receive at extremely low power so that receiving entities must be within a few centimeters of one another. Whisper mode simplifies the Bluetooth connection process by requiring close proximity between the connecting devices, and like NFC, whisper mode improves security by preventing eavesdropping and ensuring the connection is being made to the right device. One or more entities may be required to communicate via one or more of these private communication methods in order to add another level of security between devices for certain sensitive data that may be required to be more private or secure than other data, such as but not limited to data in the private vault.

Non-human entities such as electronic devices typically communicate via some electronic emission such as but not limited to RF (radio frequencies) and the like including distinctive signals that are sometimes called “noise”. These electronic emissions are distinctive to the circuits that generate them, lending the ability for one entity to recognize another entity by recognizing the distinctive characteristics of the electronic emission. Under this invention, these distinctive electronic emissions may be used to discriminate one entity from another, and thus authenticate an entity.

In some embodiments, authentication may be executed “remotely,” that is, the user enters identification information directly to the first entity or enters the identification information over a private network or enters the identification information from an entity in private communication with the first entity.

Personalized authentication defined: Successful authentication authorizes a data transfer. This data transfer may be considered “personalized” to the user/data owner in that data is linked to and thereby controlled by the data owner via a personalized authentication that only the user can perform. Only a user who has been authenticated as the data owner can initiate data transfer from one or more entities to one or more other entities.

In one non-limiting example, an entity's electromagnetic emissions will be measured to form an identification of the entity (EM-ID). Each entity has variations during manufacturing of components and final assembly that create differences in the EM signal (system noise). A software-defined radio is used to pick up and record the system noise generated by the entity and the frequencies are digitized and fed into a computer where an algorithm parses the patterns. The EM-ID is then used to link the entity to the data owner. In this example one of the data owners EM-ID's must then be present to initiate a data transfer.

In another non-limiting example, sensitive data can be encrypted using a private key stored only on the owner's personal entity that is never exchanged with any other entities. In this example the data owners' entity must be present to initiate a data transfer.

The authentication processes referred to herein may include one or more biometrics, PINs, gestures, or patterns, or any other item that can uniquely identify the user and therefore assure that the user is an authorized and legitimate user. Under some embodiments, the data is encrypted by one or more cryptographic keys that identifies a user. In other embodiments, the signature of the data is derived with a key that identifies a user, such as a biometric. In yet other embodiments, the data is associated with a specific owner through a header attached to the data, or some other form of associating the data to the user.

The authentication process may also comprise visual authentication, audio authentication, or vibrational authentication. Additionally, authentication may involve a scan of the human-verifiable visual code with a user device, the human-verifiable visual code comprising a quick response code having human-readable characters integrated therewith.

In any of the authentication examples set forth, the identification information offered by the user must be successfully matched with identification information stored in memory. The identification information for use during any authentication process may be stored on any of the entities involved in the authentication processes or stored across several entities, i.e., a portion of the identification information stored within each one of a plurality of entities such that the information needed for authentication comprises the aggregation of all such portions.

In some embodiments user identification information may be utilized to generate a token and the token, in lieu of the identification information, sent to an entity for authentication. Public or private keys may also be used for authentication. These inputs or keys may also be utilized for cryptographic salting, as in some embodiments.

After a token is generated, it may be used to authenticate both the user and the primary device with a secondary device before a data transfer. This may be achieved by generating the token with a user input that is recognized as both a user ID and a private key. In instances wherein the user ID is not recognized as a private key, a separate piece of information must be used to produce the token.

In other embodiments, user input may direct the transfer of one or more specific pieces of information embedded in the data and/or direct the transfer of data to one more other entities. For example, a user may use a fingerprint to authenticate and in that way specify the transfer of a bank account number, while then using a voice input to execute the transfer of a credit card number.

The various authentication processes may use a one-time authentication code generated dynamically for each data transfer session.

In some embodiments of the present invention, one or more authentication techniques may be used to verify an entity or a user. These may include, but are not limited to, symmetric, asymmetric, and/or combinations of any authentication techniques.

Those versed in the art will recognize that symmetric authentication methods such as a challenge-response may be used to validate one or more authentication processes. A challenge-response technique may also be used to validate encryption keys that are shared between entities to encrypt and decrypt data.

Alternatively, asymmetric methods such as generation of a public key from a private key on a first device and sending that public key to a second, third or nth device may be used to authenticate entities. In some embodiments the asymmetric technique may also be used to encrypt data transferred between entities. Those versed in the art will also recognize that one or more combinations of asymmetric and symmetric may also be used to perform authentication between entities.

Dynamic Pairing: In some embodiments, one-time use codes are generated dynamically for each data transfer session using dynamic authentication methods such as dynamic paring, which utilizes the history of risk scores as authentication. After the risk scores are produced, they are then converted into dynamic paring codes, which are sent among the two or more entities for use in an authentication process.

Define Multi-Instance: In one aspect of the present invention, it is further required that a first entity to which the user has been authenticated, is then further authenticated to a second entity before executing a data transaction. This method of authenticating with multiple devices before a transaction is performed is called “multiple Instance”.

Improved security through distributing authentication across pluralities of entities, authentication and/or communication methods: Under one embodiment, a third entity is used as a gateway such that two or more devices must be present before any transaction related to data may take place. Security is assured by requiring a plurality of authentication instances across a plurality of entities, in some embodiments, or across a plurality of authentication methods, in other embodiments, or across a plurality of communication methods, in yet other embodiments. In other embodiments, a combination of each may also be performed to improve security.

A plurality of authentication instances between a plurality of entities: For instance, a first entity (e.g., a smart phone 11 in this non-limiting example) may wish to access data from a second entity (e.g., a smart wallet or smart card 13 in this non-limiting example).

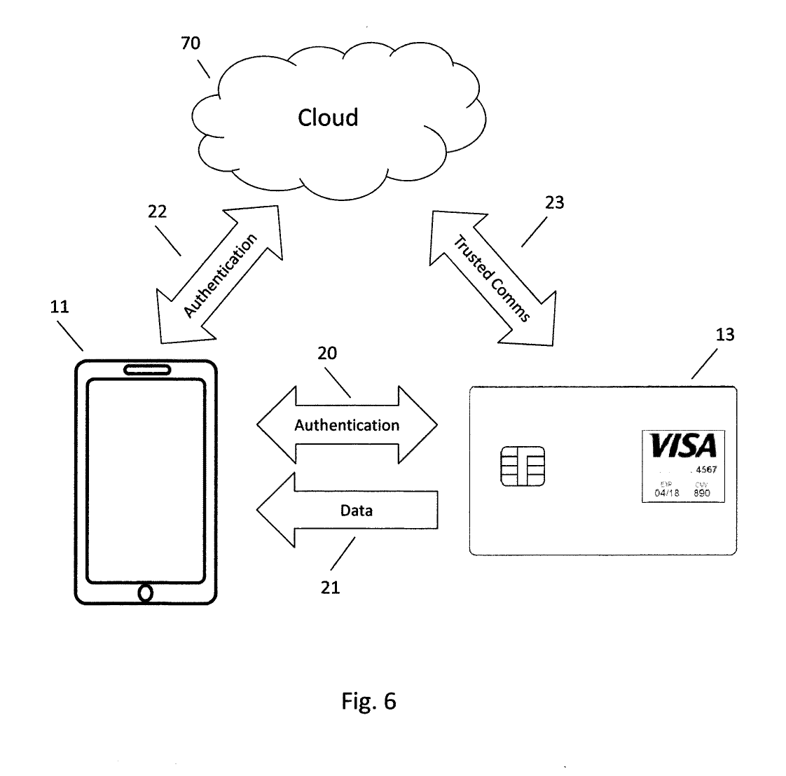

FIG. 6 illustrates a method and system wherein three entities authenticate before a data transfer. This example introduces a second authentication process depicted by the arrowhead 30 with a cloud-based entity 70. In this example, the arrowhead 22 represents a uni-directional data transfer from the entity 13 to the entity 11.

Under typical access, the first entity (phone 11) would authenticate 20 with the second entity (smart card 13) to gain access to its contents (data 21 on the smart card 13). Under this invention, the second entity (e.g., a smart card 13) may ask for additional authentication 20 prior to releasing any data 21. This additional authentication 22 may comprise the first entity (phone 11) authenticating 23 with a third entity (a user, an entity, or another device on the cloud 70 that is trusted by the second entity (smart card 13) as shown by “trusted comms” 23 (e.g., trusted communication links and systems) between a second and third entities, as non-limiting examples). Note in this example a communication process 23 can take place directly between the second entity (smart card 13 in this example) and the third entity (cloud 70 in this example), or through the first entity (communications path not shown) to reach the third entity. In this embodiment, the second entity may authenticate with the third entity through the second entity to prevent a man-in-the-middle attack). One entity requesting multiple authentication instances across a plurality of entities prior to releasing data to one or more of the entities improves the security of the data.

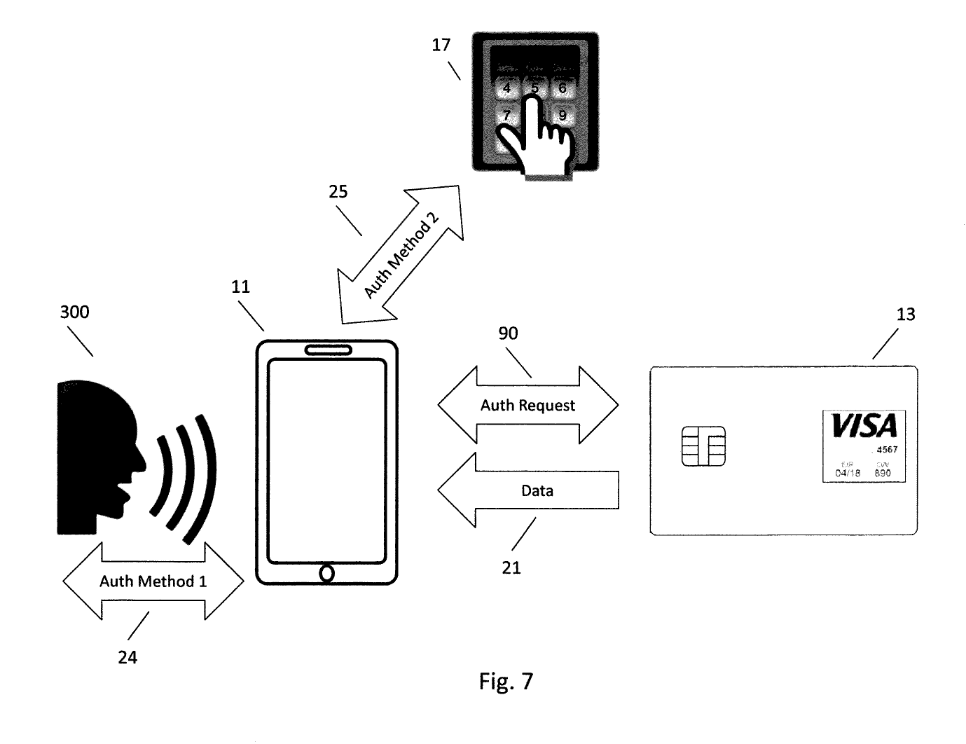

Plurality of authentication methods: Likewise, as shown in FIG. 7, a second entity (e.g., a smart card 13 in this example) may request 90 a first authentication method, “auth method 1” 24 from the first entity (e.g., a phone 11) (a biometric authentication with the owner 300 of the data 21, as a non-limiting example), and/or a second or third authentication method, “auth method 2” 25 (answering a question or entering a PIN 17 (personal identification number), as non-limiting examples) with fourth or fifth entities (a laptop or computer as non-limiting examples, not shown) to increase security and assurance of the data transfer. In other embodiments, the first device (a smart card 13) may request a third or fourth device (trusted devices from the internet of things (IOT) such as a refrigerator or television, as non-limiting examples) to authenticate the first device (phone). Multiple authentication methods and instances reduce susceptibility to comprising the data due to unauthorized access.

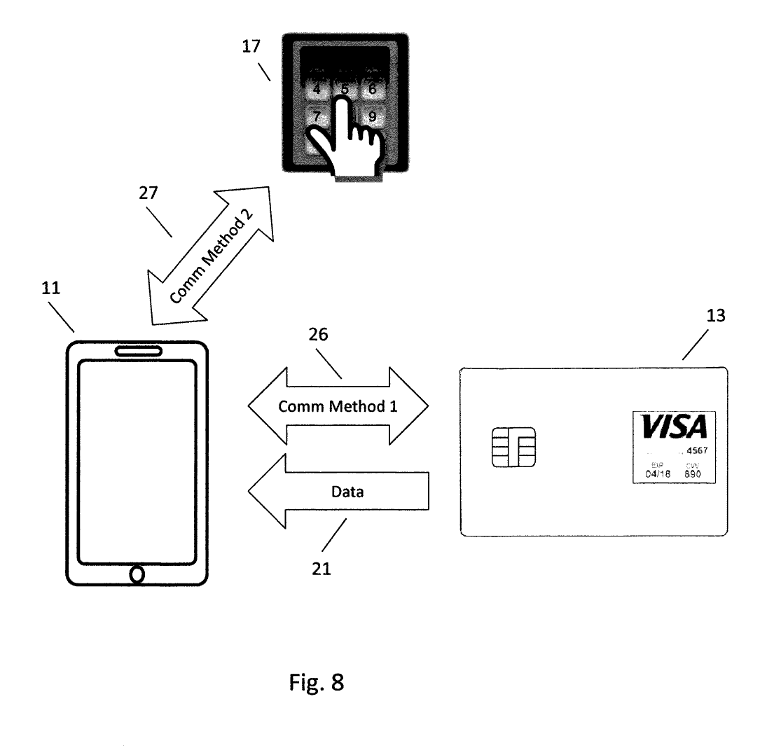

Plurality of communication methods: Similarly as shown in FIG. 8, the second entity (smart card 13) may request the first entity (phone 11) authenticate via a first communication method, “comm method 1” 26 (Bluetooth as a non-limiting example). The second entity (smart card 13) could also request the first entity (phone 11) authenticate via a second communication method, “comm method 2” 27 (NFC as a non-limiting example). The combination of a plurality of communication methods between two or more entities further improves the security of data distributed among one or more entities.

Key management for multi-instance: In some embodiments, data is encrypted with a separate key for each combination of authenticated devices. Sensitive data may be present to only selected combinations of authenticated devices. Devices may log accesses to internal databases as well as who accessed it and when. Devices may automatically select a remote device based on location, region, communication method, time, number of previous authentications and the like, or specific devices that access data, which provides the ability to disable authentication for specific locations, regions, communication methods, time, number of previous authentications and the like, or specific entities.

Distributed Private Vault: Conversely, devices may also request authentication instances between a device requesting access to information or data and specific trusted entities, where the authentication instances may be a specific authentication or communication method. For a non-limiting example, data may be configured to be backed-up or restored only between specific “trusted entities”, “trusted communications”, and/or “trusted authentication methods”. In some embodiments, at least one portion of the data may also be distributed among trusted entities within this ecosystem to increase security by requiring a plurality of devices be present to access the data. This inner ecosystem is the most secure of within the inner circle of access and referenced as the “distributed private vault” or “private vault”, herein.

The present invention can be used in conjunction with any data transfer or data access between two or more entities including but not limited to data release, data distribution, data backup, data restore, payment or financial transactions and the like.

Another non-limiting example of the system and method of the present invention involves a first entity authenticating with one or more other entities prior to any data transfer. A non-limiting example of this embodiment encompasses a first entity (such as a smart wallet) storing sensitive private information (such as credit card or bank account information, referred to generally as financial information and considered “personal information”) authenticating with a second entity, such as but not limited to a computer or a USB (universal serial bus) memory device storing private information physically connected to a computer) and authenticating with a third entity (such as a cloud-based server) before any data is transferred from the first entity.

In a derivative of this embodiment, the first entity may authenticate directly with the second and third entities, or the first entity may authenticate directly with only the second entity and the second entity then authenticates with the third entity. In any case, after all the authentication instances have been completed all three of the entities are authenticated to each other.

In another derivative of this embodiment, the user must first authenticate to the smart wallet (which is the first entity) before the smart wallet authenticates to the second entity.

According to another embodiment, the first entity authenticates with the second entity as well as with a third entity, wherein the third entity comprises a software application executing on the second entity.

The application may then authenticate with a fourth entity, such as a cloud-based server, before transferring data to or receiving data from the fourth entity. Alternatively, once the software application has been authenticated to the first, second, and fourth entities (either directly or indirectly) data can be transferred between and among any of these entities.

Yet another method of the present invention utilizes a trusted third party, including but not limited to a certificate authority, a business enterprise or an individual, to authenticate and therefore authorize the release of information or data from one entity to another entity. Herein the trusted third party does not store the information or data, but only adds security through conducting authentication processes.

After authentication has been completed, data may be released, distributed, backed-up, restored, etc. In some embodiments where backup is performed, the entity receiving the information for backup may be configured to restore the information only to an authenticated entity.

Communicating entities (other than humans) also need to authenticate to each other to ensure that both entities are authorized to conduct a specific transaction. The authentication process verifies that first and second entities or devices are authorized to interact. Requiring authentication between entities prevents access to either entity by a hacker. Authentication in these machine cases can be performed by passing credentials to one other. These credentials may be, in some circumstances

Backing up data stored on a first device by transferring that data to a second device is one example of a data transfer. Restoring data that had been stored on a first entity (but is then corrupted or lost), by supplying that data from a second entity is another type of data transfer. In one application of this embodiment the first or second entity comprises a smart wallet.

Such entities may further include, but are not limited to, mobile devices (such as wallets, cell phones and dongles); wearable devices (such as watches, wrist bands and eye glasses); other traditionally static devices (such as desktops, routers, and servers); clouds or cloud-based devices such as servers; software applications and other software executing on a processor-based device (such as a mobile phone or a cloud-based server); internet of things (IOT) devices (such as thermostats, music controllers and refrigerators); and virtually any memory component or any device that stores and processes data.

Additional entities may comprise a memory chip, a crypto chip, a microprocessor, a microcontroller, software applications, and devices incorporating any such components. Certain of these entities may be tamperproof.

In some embodiments of the present invention, data stored on a first entity (also referred to as a primary entity) is backed-up to one or more separate entities referred to as “second entities.” Other entities referred to herein as “third entities” and/or “forth entities”, and so on, may be used for data storage only, for authentication only, or for both data storage and authentication.

Entities associated with the present invention can communicate using any communication technique or system, including but not limited to, wireless communication techniques (e.g., acoustic, light, RFID (Radio Frequency Identification), NFC (Near Field Communication), Bluetooth or BLE (Bluetooth low energy), WiFi, PAN (personal area network)). Certain of these communication techniques may be considered public networks and others considered private networks.

Other embodiments may employ physical (e.g., wired) connections such as parallel or serial data links, including but not limited to, communications over a universal serial bus (USB).

Communications between entities may also be classified as communications between local entities and communications between remote entities. Generally, according to certain embodiments of the present invention, a user authenticates to a first entity (e.g., by directly accessing the first entity through physical presence or by accessing over a network) after which the first entity authenticates to a second entity. If both authentications are successful, data is transferred from the first to the second entity, or to a third entity.

In certain embodiments, the authentication processes, sometimes referred to herein as “authentication instances,” are executed over a public network and the data transfer occurs over a private network. Use of a private network for the data transfer reduces the likelihood of hacker interception of the data.

In one embodiment, a first entity authenticates with one or more of second, third, and nth entities before information is transferred. Once authenticated a first entity may send data to a second, third, or nth entity. In some embodiments, both the authentication information and the data may be encrypted with the same encryption keys. In other embodiments, data may be encrypted with a separately-generated encryption key.

In some non-limiting embodiments, a second, third or nth entity storing data (for example, backup data) may only transfer data (for example restore the data) to a primary entity. In some embodiments, restoration may only take place after the entity performing the restoration has authenticated with one or more of the other entities.

Authentication between more than one entity prior to data transfer increases security by decreasing the possibility of a hack, since multiple entity authentication is required.

Likewise, storing data on an entity local to a user rather than on a third party service decreases chances of a hack.

Furthermore, disconnected storage with intelligently connected authentication decreases the possibility of an unauthorized data breach, such as the unauthorized release of private data from a user's smart wallet.

As in one non-limiting example, a first entity, such as the smart wallet, may request to backup personal information stored on the smart wallet to a second, third or nth entity. A primary entity holding sensitive private information (such as a smart wallet) may authenticate with a secondary entity (such as a USB memory device connected to a computer), or to a tertiary entity (such as an application on the computer), and/or additional entities (such as a cloud based server) before information is transferred to any other entity. In this embodiment, the second entity (a USB memory device) and/or the primary device (the smart wallet) may also authenticate with a third entity (such as a cloud based server) prior to transfer of data.

In some embodiments, information may be held or stored locally by an entity, so that all data is under a user's control since the user exercises control over the entity. The entity holding the information may be disconnected from any network or device.

In certain embodiments, even after successful authentication, the data may be configured to prohibit its release over specific communications channels, such as devices with insecure operating systems communicating over the Internet or another public network. The entity storing the data may authenticate over the Internet (or over another communications link) but data is sent to another entity only a secure communications link.

In some embodiments, the backup entity may also authenticate with a third party authoritative entity including but not limited to a certificate or certification authority.

An authoritative entity may be a controlling yet secured third party or a “gateway” as in one method of the present invention. Herein the authoritative entity may authenticate both the one or more first/primary entities and/or the one or more backup entities. In some non-limiting embodiments, information may not be shared unless the first entity and the authoritative entity authenticate and therefore authorize the release of information to or from the secondary entity. Because information is not backed-up to the authoritative entity in this method, further security is added by keeping the stored information under the local control of the user.

Each entity may connect to one another “intelligently”, meaning only when required to perform a data transfer. Transfer features of the data may include but are not limited to release, distribution, backup, and restoration. Data may include any data that the user requires, such as personal data, files, emails, or any other information that the user/owner wishes to transfer.

All entities may request any other entity to authenticate the user prior to authorizing any transfer of data. User authentication may consist of any of the aforementioned methods that use user input (knowledge), an entity or device (possession), biometrics (inherence), and/or behavior metrics (movement or action) to validate the user is who he or she says he or she is. The data may be, in one embodiment, linked or related to the user in several manners including but not limited to using a key associated with the user to encrypt, encode, provide a signature, and the like to the data so that it is always “associated” with the user. In this manner, the backup and restore functions are “personalized” to the user.

An advantage of the personalized authentication methods and systems described herein is that data is associated to the owner of the data. This lends itself to architectures and systems wherein the owner may give access or release data from one or more entities. Although once released data is outside of the control of an owner, signatures, encryption, encoding and other methods that encode the data with keys derived from some unique feature that only an owner has or knows further protects the data even after it is released.

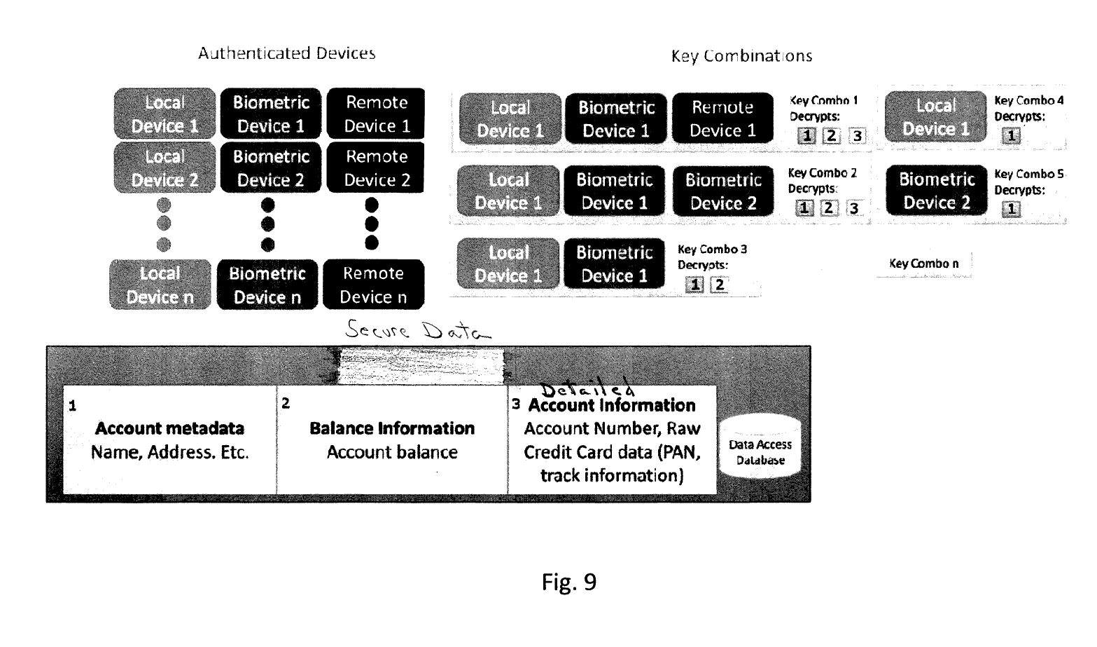

One non-limiting example of the present invention is illustrated in FIG. 9. Example authenticated devices are indicated as local device 1 through n, biometric devices 1 through n, and remote devices 1 through n. These devices are capable of being authenticated and once authenticated can participate in data transfer, access, etc.

Certain different combinations of the authenticated devices permit access to more sensitive information. As shown, the combination of authentication instances involving local device 1, biometric device 1, and remote device 1 permit access to all three of the data types illustrated, i.e., account metadata, account balance information, and detailed account information (referred to as data access/database in FIG. 9).

FIG. 9 is intended to illustrate a data backup scenario and thus the key combination of local device 1, biometric device 1, and remote device 1 can decrypt the backed up data as stated in FIG. 9. But the invention is not so limited as the concepts set forth in FIG. 9 can be applied to access, transfer, back up, etc. of any sensitive data.

As seen, the key combination involving authentication by only device 1 restricts decryption of only the metadata. No access can be gained to the balance information or to the detailed account information.

According to another embodiment, access or data transfer of sensitive or private data can be encrypted using a private key stored only on the owner's personal entity that is never exchanged with any other entities. Therefore, the data can be released out of the owners' control yet be unreadable until the owner is back in control (e.g. an owner backing data up to separate entity (data is unreadable) and restoring the data at a later time (data can now be read only by owners' entity)).

In another none-limiting example, the sensitive data is encrypted with the owners' entity private key and the sensitive data is also encrypted with a combination of a secondary device and the owners' biometric key. In this example if the owner lost their primary entity they can recover their data with the secondary device and the owners' biometric. However, without the secondary device and biometric, or their primary entity, their data cannot be decrypted by any other device.

Upon initial configuration of the system, a supplier of a product, for example, could act as a “gateway” to ensure that the two devices indeed belong to the same owner. For instance, a vendor could configure a smart wallet, as a non-limiting example, to associate with another specific entity, such as a backup entity. Both entities being “known” by the vendor (third entity) may configure the first and second devices before a user's information is sent to the smart wallet.

In a non-limiting example, supplier ships a smart wallet to a purchaser/user. The user authenticates to the smart wallet (a second device) and to a first device (a back-up device such as a USB drive in this non-limiting example) or an application executing on that second entity. The second entity back-up device) then authenticates with the supplier's cloud based server. If authentication with both the smart wallet and the cloud based server is successful, then the data is authorized to be transferred from the second device to a first device in order to perform a back-up, or in other embodiments, the data is authorized to restore from a first device to a second device.

Certain terms used in the present application are commonly used and known by those skilled in the art. However, by way of example only, a local device may comprise a device that is a member of the Internet-of-things class, such as a refrigerator. Such local devices may also be located within one's home or business premises, such as a business device or a business LAN. An example of social entity logons may include FaceBook logon credentials. And an example of a retail entity logon may include Amazon logon credentials. Personal devices may include a laptop, a desktop computer or a wearable item. Remote servers may comprise a cloud-based server.

One aspect of the present invention relates to authentication across multiple devices to improve data security, especially during data transfer. A related concept of collaborative services across multiple devices is described and claimed in a co-owned application entitled Distributed Method and System to Improve Collaborative Services Across Multiple Devices, filed on Feb. 8, 2016 and assigned application Ser. No. 15/018,496, which is incorporated by reference herein.

In addition to application of the teachings of the present invention to data, the teachings can also be applied to a data token (tokenization), which generally refers to substituting a sensitive data element with a less sensitive data element, the latter referred to as a token.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims

What is claimed is:

1. A system employing distributed authentication prior to permitting data access or data transfer, the system comprising:
data stored at a first entity;
during a first authentication instance a second entity authenticating with the first entity;
during a second authentication instance the second entity authenticating with a third entity;
the third entity is considered a trusted entity or if not considered a trusted entity then during a third authentication instance the third entity authenticating with the first entity;
if the second authentication instance is successful, the second entity advising the first entity; and
if the first, second, and third authentication instances are successful, or in lieu of a successful third authentication instance the third entity is considered a trusted entity, the data permitted to be transferred or accessed from the first entity.

2. The system of claim 1 wherein the third entity is a trusted entity responsive to a prior successful authentication with the first entity.

3. The system of claim 2 wherein the prior successful authentication was executed within a time interval of predetermined length prior to a present time.

4. The system of claim 1 wherein the third entity is a trusted entity responsive to a static geo-location relative to the first entity.

5. The system of claim 1 wherein the third entity is one of a plurality of trusted entities known to the first entity.

6. The system of claim 1 wherein the third entity is a local entity relative to the first entity, wherein a local entity comprises an entity communicating with the first entity over an NFC, Bluetooth, or WiFi communication protocol.

7. The system of claim 1 the first entity requiring one or more additional authentication instances with one or more additional entities prior to permitting data transfer or access from the first entity.

8. The system of claim 1 wherein data transferred or accessed from the first entity comprises making a payment by the first entity.

9. The system of claim 1 a first data portion stored at the first entity and a second data portion stored at another entity, if the first and second authentication instances are successful, the first data portion and the second data portion permitted to be transferred or accessed.

10. The system of claim 1 wherein a user selects one or both of the second and third entities from among a plurality of entities capable of executing an authentication process with the first entity.

11. The system of claim 10 wherein the user selects one or both of the second and third entities from among the plurality of entities responsive to a sensitivity of the data to be transferred or accessed from the first entity.

12. The system of claim 1 further comprising a human user must successfully authenticate with one or both of the second and third entities prior to data transfer or access from the first entity.

13. The system of claim 12 wherein the user authenticating with one or both of the second and third entities comprises the user providing a biometric for authenticating.

14. The system of claim 1 at least a portion of the data comprising private data, and wherein the private data can be transferred or accessed from the first entity only to an identified and authenticated receiving entity.

15. The system of claim 1 the data to be transferred or accessed from the first entity to a plurality of receiving entities, each one of the plurality of receiving entities comprising a trusted entity or authenticating with the first entity prior to the data transfer or access.

16. The system of claim 15 the trusted entity considered a trusted entity by the first entity or considered a trusted entity by another entity where the another entity has successfully authenticated with the first entity.

17. The system of claim 1 at least one of the first, second, and third entities comprises a human user.

18. The system of claim 1 the first authentication instance executed using a device connected to the first entity over a private network or by entering authentication information directly to the first entity, and the second authentication instance executed over a public network.

19. The system of claim 18 wherein the private network comprises a private WiFi network, a Bluetooth network, a Bluetooth low energy network (BLE), a peer-to-peer network, an ultrasonic network, a personal area network (PAN) and the public network comprises the Internet.

20. The system of claim 1 wherein the first, second, and third authentication instances are executed using at least two different communication protocols.

21. The system of claim 1 wherein one of the first, second, and third authentication instances is executed over a different communication interface than a communication interface over which data is transferred or accessed from the first entity.

22. The system of claim 1 wherein the data transferred or accessed includes at least a portion of a payment account or a token.

23. The system of claim 22 wherein a payment is permitted by one of a plurality of entities only after the first authentication instance and the second authentication instance are deemed successful.

24. The system of claim 1 wherein at least one of the first, second and third entities comprises a wearable, an Internet of Things device (IOT), a cloud-based device, stationary device, a mobile device or a portable device.

25. The system of claim 1 wherein the first entity transfers the data through a physical connection between the first entity and a receiving entity or transfers the data over a private network connecting the first and the receiving entity.

26. The system of claim 1 wherein at least one entity comprises a cloud-based entity.

27. The system of claim 1 wherein the first entity transfers the data to a receiving entity to back up the data to the receiving entity or to restore the data to from receiving entity.

28. The system of claim 1 wherein the data is encrypted prior to transferring or accessing from the first entity.

29. The system of claim 28 wherein the data is encrypted using an encryption key comprising a first and a second segment, both the first and second segments required to encrypt and decrypt the data, wherein the first segment is stored on one of the first, second, and third entities, and the second segment is stored on another of the first, second, and third entities.

30. The system of claim 1 further comprising the first entity transferring the data to the second entity, and the second entity at a later time restoring the data to the first entity over a private network.

31. The system of claim 1 wherein the first entity serves as a data back-up device for data stored on the second or third entities, and at least one of the second and third entities comprises a smart wallet, a smart phone, or an Internet-or-Things device.

32. The system of claim 1 wherein the first and second entities utilize one or more of symmetric codes, asymmetric codes, a combination of symmetric and asymmetric codes, one-time use codes, or dynamic pairing codes during the first, second, and third authentication instances.

33. The system of claim 1 wherein the second entity is a local entity relative to the first entity.

34. The system of claim 1 wherein at least two of the first, second, and third entities are proximately located entities such that information provided for use during one or more of the first, second, and third authentication instances is received by both of proximately located entities.

35. The system of claim 1 wherein an owner of the data who has been authenticated to the first entity can initiate transfer from the first entity to one or more other entities even if one or more of the first, second, and third authentication instances are unsuccessful.

36. The system of claim 1 wherein only a data owner determines authentication instances and authentication methodologies for use in authorizing transfer of the data

37. The system of claim 1 wherein an authentication instance is based on one or more of entity knowledge, entity possession, entity inherence, and entity behavior.

38. The system of claim 1 wherein a receiving entity is connected to the first entity for receiving the data only during a time interval when connectivity is required to transfer data.

39. The system of claim 1 wherein the data is linked to a user or data owner who controls additional requirements that must be satisfied prior to transfer or access of the data from the first entity, these requirements in addition to successful first, second and third authentication instances.

40. The system of claim 1 wherein during the first authentication instance the second entity authenticating with the first entity through the third entity or during the second authentication instance the second entity authenticating with the third entity through the first entity.

41. The system of claim 1 wherein an owner of the data is identified in a data header segment of the data.

42. The system of claim 1 wherein one or more of the first, second and third authentication instances are executed by examining an electronic emission spectrum of the second entity or of the third entity.

43. The system of claim 1 wherein transfer of or access to the data is restricted according to one or more of the following restrictions: no restrictions on data transfer or access thereby permitting public access to the data; requiring a prior acknowledgment from a receiving entity before the data is transferred to or accessed by the receiving entity; requiring authentication with the receiving entity if there has been no authentication with the receiving entity for a predetermined prior time interval; requiring one or more authentication instances before data is transferred to or accessed by the receiving entity; requiring one or more authentication instances with one or more of a plurality of entities before the data is transferred to or accessed by the receiving entity; requiring use of at least two different communications techniques for at least two authentication instances; requiring a receiving entity to have a specific location or proximity relative to the first entity; denying data transfer to or access by a receiving entity at a specific location; and requiring predetermined entities to execute predetermined authentication instances prior to data transfer or access.

44. A system employing distributed authentication prior to transferring or accessing data from a first entity, the system comprising:
the first entity for storing data;
during a first authentication instance a user authenticating with the first entity over a private network or by a physical connection with the first entity;
during a plurality of additional authentication instances the first entity authenticating with a like plurality of entities; and
after the first and at least one of the plurality of authentication instances are deemed successful, the first entity transferring the data or permitting access to the data by one of the plurality of entities.

45. A system employing distributed authentication prior to transferring data from a smart wallet, the system comprising:
the smart wallet for storing personal information;
during a first authentication instance a user authenticating with the smart wallet;
during a second authentication instance the smart wallet authenticating with a local entity over a private network or over a physical connection between the smart wallet and the local entity;
during a third authentication instance one or both of the smart wallet and the local entity authenticating with a remote entity over a public network; and
after the first, second and third authentication instances are deemed successful, the smart wallet transferring the data to one or both of the local entity and the remote entity.

46. The system of claim 45 wherein during the first authentication instance the user presents biometric information to the smart wallet, and wherein the biometric information is not transferred to the local entity or to the remote entity.

47. The system of claim 45 wherein the remote entity comprises a cloud-based entity.

48. The system of claim 45 wherein after the first, second and third authentication instances are deemed successful, the smart wallet transferring the data to the local entity.

49. The system of claim 45 further comprising a back-up entity, wherein the back-up entity transfers the data to a receiving entity after at least two authentication instances from among the first, second, and third authentication instances are deemed successful.

50. A system employing distributed authentication prior to transferring data from a first entity, the system comprising:
the first entity for storing data;
during a first authentication instance a user authenticating with the first entity by entering identification information directly to the first entity;
during a second authentication instance the first entity authenticating with a second entity over a public network; and
after the first and second authentication instances are deemed successful, the first entity transferring the data to the second entity over a private network.

51. A system employing cascading authentication prior to transferring data from a first entity, the system comprising:
during a first authentication instance a second entity authenticating with the first entity;
during a second authentication instance the second entity authenticating with a third entity; and
if the first and second authentication instances are successful, the first entity transferring the data to the third entity.
